(19) United States
(12) Patent Application Publication
(10) Pub. No.: US 2021/0073569 A1
(43) Pub. Date: Mar. 11, 2021

(54) POOLING DEVICE AND POOLING METHOD

(71) Applicant: SZ DJI TECHNOLOGY CO., LTD., Shenzhen (CN)

(72) Inventors: Mingming GAO, Shenzhen (CN); Qian GU, Shenzhen (CN); Kang YANG, Shenzhen (CN)

(21) Appl. No.: 16/952,911

(22) Filed: Nov. 19, 2020

Related U.S. Application Data
(63) Continuation of application No. PCT/CN2018/088959, filed on May 30, 2018.

(51) Int. Cl. G06K 9/46; G06F 12/0875; G06N 3/08; G06K 9/32; G06K 9/00

(52) U.S. Cl. CPC G06K 9/4642; G06F 12/0875; G06F 2212/455; G06K 9/3233; G06K 9/00986; G06N 3/08

(57) ABSTRACT

A pooling device includes one or more first processing circuits and one or more second processing circuits. The one or more first processing circuits are configured to compute temporary pooling results of an input image along a row direction or a column direction. The one or more second processing circuits are configured to generate an output image according to the temporary pooling results of the input image along the row direction or the column direction.

### CROSS-REFERENCE TO RELATED APPLICATION

This application is a continuation of International Application No. PCT/CN2018/088959, filed May 30, 2018, the entire content of which is incorporated herein by reference.

### TECHNICAL FIELD

The present disclosure generally relates to the artificial intelligence (AI) field and, more particularly, to a pooling device and a pooling method.

### BACKGROUND

With the development of artificial intelligence (AI), convolutional neural networks (CNN) have achieved good results in image classification and image segmentation.

Currently, major manufacturers have begun to convert the computing process of the CNN into hardware and hoped to realize CNN's on-chip computing in a form of a chip.

The CNN usually includes neural network layers, such as a convolutional layer, a pooling layer, etc. The pooling layer is configured to perform a pooling computation. The pooling computation includes general pooling and region of interest (ROI) pooling. A pooling operation includes maximum pooling and average pooling. Different pooling computations and/or pooling operations have different requirements for the hardware, thus the design of the hardware is difficult.

### SUMMARY

Embodiments of the present disclosure provide a pooling device including one or more first processing circuits and one or more second processing circuits. The one or more first processing circuits are configured to compute temporary pooling results of an input image along a row direction or a column direction. The one or more second processing circuits are configured to generate an output image according to the temporary pooling results of the input image along the row direction or the column direction.

Embodiments of the present disclosure provide a neural network processor including a convolutional device and a pooling device. The pooling device includes one or more first processing circuits and one or more second processing circuits. The one or more first processing circuits are configured to compute a temporary pooling result of an input image from the convolutional device along a row direction or a column direction. The one or more second processing circuits are configured to generate an output image according to the temporary pooling result of the input image along the row direction or the column direction.

Embodiments of the present disclosure provide a pooling method. The method includes computing, using one or more first processing circuits, temporary pooling results of an input image along a row direction or a column direction and generating, using one or more second processing circuits, an output image according to the temporary pooling results of the input image along the row direction or the column direction.

### BRIEF DESCRIPTION OF THE DRAWINGS

FIG. 1 is a schematic structural diagram of a pooling device according to some embodiments of the present disclosure.

FIG. 2 is a schematic diagram showing a computation manner of a first processing circuit for an input image according to some embodiments of the present disclosure.

FIG. 3 is a schematic diagram showing another computation manner of the first processing circuit for the input image according to some embodiments of the present disclosure.

FIG. 4 is a schematic diagram showing a connection relationship between the first processing circuit and an on-chip cache according to some embodiments of the present disclosure.

FIG. 5 is a schematic structural diagram of the on-chip cache according to some embodiments of the present disclosure.

FIG. 6 is a schematic structural diagram of a neural network processor according to some embodiments of the present disclosure.

FIG. 7 is a schematic flowchart of a pooling method according to some embodiments of the present disclosure.

### DETAILED DESCRIPTION OF THE EMBODIMENTS

Convolutional neural networks (CNN) may include at least one neural network layers, such as a pre-processing layer, a convolutional layer, an activation layer, a pooling layer, and/or a fully connected layer.

The pooling layer may be mainly configured to perform a pooling operation. The pooling layer may perform a pooling operation for an input image by using a pooling window as a unit. A width of the pooling window may be used to identify a number of columns of pixels included in the pooling window. Correspondingly, a height of the pooling window may be used to identify a number of rows of the pixels included in the pooling window. The width and the height of the pooling window may be the same or different. Values of the width and the height may be selected according to actual needs, which are not limited by embodiments of the present disclosure. The pooling window may sometimes be referred to as a sliding window or a pooling core of the pooling operation.

The pooling operation may include a plurality of types, such as average pooling and max pooling. The average pooling may be used to calculate an average value of the pixels included in the pooling window. The max pooling may be used to calculate a maximum value of the pixels included in the pooling window. For example, for the average pooling, pixel values of the pixels of the pooling window may be summed up first, then the average value of the pixels may be computed. For example, for the max pooling, the pixel values of the pixels of the pooling window may be compared in pairs. Then, a final comparison result may be the maximum value of the pixels of the pooling window.

The pooling operation may need to process the pixels of the pooling window in sequence. After the pixels of the pooling window are processed, a final pooling result may be generated. Before obtaining the final pooling result, the pooling operation may generate a temporary pooling result. Temporary pooling results of a row direction may refer to temporary pooling results obtained by processing row pixels of the input image. A number of the temporary pooling results corresponding to pixels of a row of the input image may be the same as the column number of the output image needed to be obtained after the input image passes through the pooling layer. Similarly, temporary pooling results of a column direction may refer to temporary pooling results obtained by processing column pixels of the input image. A number of temporary pooling results corresponding to pixels of a column of the input image may be the same as the row number of the output image needed to be obtained after the input image passes through the pooling layer. For example, for the average pooling, a temporary pooling result of the row direction of the input image may refer to an accumulated pixel value of pixels of the row pixels belong to the pooling window. The temporary pooling result of the column direction of the input image may refer to an accumulated pixel value of pixels of the column pixels belong to the pooling window. For example, for the maximum pooling result, the temporary pooling result of the row direction of the input image may refer to a maximum pixel value of the pixels of the row pixels of the input image belong to the pooling window. The temporary pooling result of the column direction of the input image may refer to a maximum pixel value of the pixels of the column pixels of the input image belong to the pooling window.

According to different pooling objects of the pooling layer, a pooling process corresponding to the pooling layer may include general pooling and region of interest (ROI) pooling. For the general pooling, the pooling operation may be performed on a whole input feature image. For the ROI pooling, the pooling operation may be performed on one or more image blocks of the whole input feature image. The one or more image blocks may be referred to as ROIs. Before the ROI pooling is performed, an analysis may be performed on positions (e.g., row and column coordinates of the ROIs in the input feature image) of the ROIs in the input feature image. According to the analyzed positions of the ROIs, image data of the ROIs may be extracted from the input feature image as input images to-be-pooled. Different ROIs may be located at different positions of the input feature image. Lengths and/or widths of different ROIs may always vary. Therefore, for the ROI pooling, a dimension of an image is usually varying, and hardware design is difficult. Thus, in the existing technology, the ROI pooling is generally implemented by software.

Embodiments of the present disclosure provide a universal pooling device. The pooling device may be configured to implement the general pooling as well as the ROI pooling.

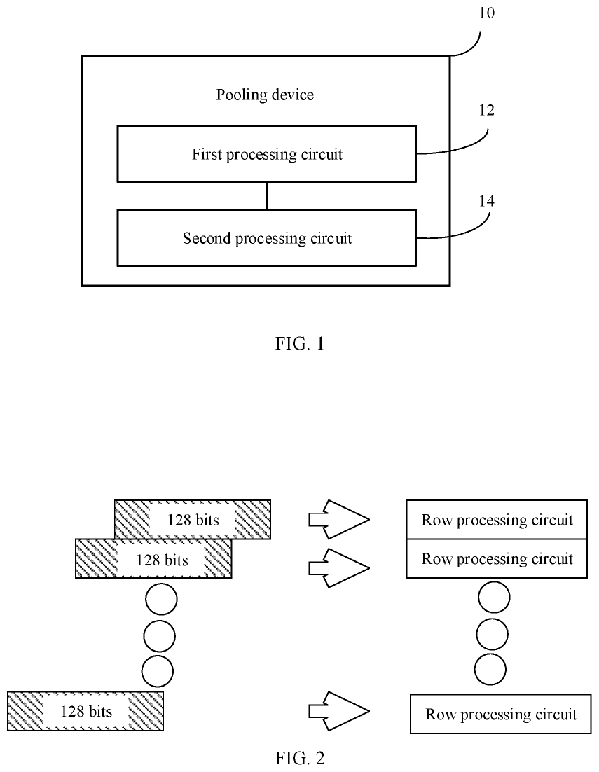

The pooling operation of the CNN is described as an example. However, application scenarios of the pooling device consistent with embodiments of the present disclosure are not limited to the above description. The pooling device may be applied in any other scenario in which the pooling operation needs to be performed. In connection with FIG. 1, the pooling device consistent with embodiments of the present disclosure is described in detail.

FIG. 1 shows a pooling device 10 consistent with embodiments of the present disclosure, which is configured to perform the pooling operation on an input image to generate a pooled output image. The pooling device 10 may include a hardware circuit (or a chip), such as a field-programmable gate array (FPGA) or an application-specific integrated circuit (ASIC). For example, when the pooling device 10 is configured to perform the general pooling, the input image may include a portion of a feature image input by a convolutional layer or the entire feature image. In another example, when the pooling device 10 is configured to perform the ROI pooling, the input image may include a portion of an ROI of the feature image input by the convolutional layer or the entire ROI. For example, when a dimension of an image in an ROI is large, the image of the ROI may be further divided into a plurality of smaller images, which may be used as the input images.

As shown in FIG. 1, the pooling device 10 includes one or more first processing circuits 12 and one or more second processing circuits 14.

The one or more first processing circuits 12 may be configured to compute the temporary pooling results of the input image along the row direction or along the column direction. When the one or more first processing circuits 12 are configured to compute the temporary pooling results of the input image along the row direction, the one or more first processing circuits 12 may be referred to as row-processing circuits. Similarly, when the one or more first processing circuits 12 are configured to compute the temporary pooling results of the input image along the column direction, the one or more first processing circuits 12 may be referred to as column-processing circuits.

The one or more second processing circuits 14 may be configured to generate the output image according to the temporary pooling results of the input image along the row direction or the column direction.

For example, the one or more second processing circuits 14 may be configured to process the temporary pooling results output by the one or more first processing circuits 12 along a direction perpendicular to a processing direction of the one or more first processing circuits 12 to obtain the output image.

A pooling process may need to perform a computation pooling window by pooling window. That is, a final pooling result may be first computed for a current pooling window, then, a next pooling window may be computed. Embodiments of the present disclosure may not follow the above pooling process. The pooling computation may be first performed on the input image along the row direction (or the column direction) of the input image to obtain the temporary pooling results. Then, the final pooling result (e.g., the pixels of the output image) of the input image may be generated and computed according to the computed temporary pooling results. Such a pooling manner may be universal, which may cause the hardware design of the pooling process to become simple.

In some embodiments, the first processing circuit 12 and the second processing circuit 14 may be individual hardware circuits or share a same circuit. In some other embodiments, the second processing circuit 14 may reuse the first processing circuit 12. The first processing circuit 12 and the second processing circuit 14 sharing the same circuit may simplify the structure of the pooling device 10 and reduce the cost of the pooling device 10.

The first processing circuit 12 may process the computation (e.g., a single-point computation) corresponding to a pixel, or the computation corresponding to a plurality of pixels every clock cycle. A type of the computation corresponding to the pixel may be related to a type of the pooling operation and the position of the pixel in the image, which is not limited by embodiments of the present disclosure. For example, the computation corresponding to the pixel may include a comparison between a pixel value of the pixel and a pixel value of a neighboring pixel, a summation of the pixel values of the pixel and the neighboring pixel, a boundary dividing operation when the pixel is located at the boundary of an image block, storage of the temporary pooling result corresponding to the pixel, etc.

If the first processing circuit 12 processes the computation corresponding to the plurality of pixels every clock cycle, a plurality of computation instructions corresponding to the plurality of pixels may be input to the first processing circuit 12, which may be complicated to implement. In contrast, if the first processing circuit 12 is controlled to perform the single point computation every clock cycle, logic control of the pooling device 10 may become simple.

In embodiments of the present disclosure, a number of the first processing circuits 12 included in the pooling device 10 may not be limited. In some embodiments, the pooling device 10 may only include one first processing circuit 12. In this case, the first processing circuit 12 may process the input image row by row or column by column.

In some other embodiments, the pooling device 10 may include the plurality of first processing circuits 12. The plurality of first processing circuits 12 may compute in parallel the temporary pooling results corresponding to the pixels of a plurality of rows or a plurality of columns of the input image. The parallel computation of the pixels of the plurality of rows or the plurality of columns may improve the computation efficiency of the pooling device.

Further, a number of the first processing circuits 12 included in the pooling device 10 may be matched with a number of the clock cycles needed for one first processing circuit 12 to process target pixels. The target pixels may be to-be-processed pixels received by the one first processing circuits 12 in a clock cycle.

Assume that the one first processing circuit 12 may need N clock cycles to process the target pixels, the number of the first processing circuits 12 included in the pooling device 10 may be set to N. Assume that the pooling device 10 may transmit the target pixels to 1st to N-th first processing circuits 12 from k-th to (k+N)-th clock cycles, respectively. Since the one first processing circuit 12 may need N clock cycles to process the target pixels, at a (k+N+1)-th clock cycle, the 1st first processing circuit 12, which receives the target pixels first, may just finish processing the target pixels received previously, such that the 1st first processing circuit 12 may receive new target pixels at the (k+N+1)-th clock cycle. Therefore, the number of the first processing circuits 12 included in the pooling device 10 may be matched with the number of the clock cycles needed by the one first processing circuit 12 processing the target pixels. As such, the processing process of each first processing circuit may achieve a tight pipeline, and the parallelism and the computation efficiency of the pooling device may be improved.

To facilitate understanding, examples are described in more detail below in connection with FIG. 2, in which the first processing circuit 12 is used as the row-processing circuit and the pixels of the input image are input to the pooling device along the row direction. During the hardware design, a clock frequency of a system, a bus width, and cost of the system may be balanced. Assume that the system, to which the pooling device 10 of embodiments of the present disclosure belongs, has a main frequency of 1 GHz and a bus width of 128 bits, and each pixel includes 8 bits of pixel data, then, the system may input 16 continuous pixels (e.g., corresponding to the above target pixels) along the row direction to a row-processing circuit of the pooling device 10 in a clock cycle. Assume that the row-processing circuit may perform the single point computation for one pixel in a clock cycle, then, the row-processing circuit may require 16 clock cycles to process the 16 pixels. In this case, a number of the row-processing circuits of the pooling device 10 may be set to 16.

According to the above setting, assume that the system operates with full bandwidth, then, for each row-processing circuit, a 128-bit pixel data may be processed in 16 clock cycles. After the 128-bit pixel data is processed, new 16 pixels may be input to the row-processing circuit in a next clock cycle. As such, each row-processing circuit may achieve a tight pipeline, and the parallelism of the system may be improved.

FIG. 2 shows an example of the pixels of the input image being input to the pooling device along the row direction, but embodiments of the present disclosure are not limited to this example. The pixels of the input image may also be input to the pooling device along the column direction. In this case, the 16 pixels input in a clock cycle may belong to 16 rows of the input image, respectively. Therefore, as shown in FIG. 3, the 16 pixels may be input to the 16 row-processing circuits in each clock cycle, respectively, to cause each row-processing circuit to obtain 8-bit pixel data.

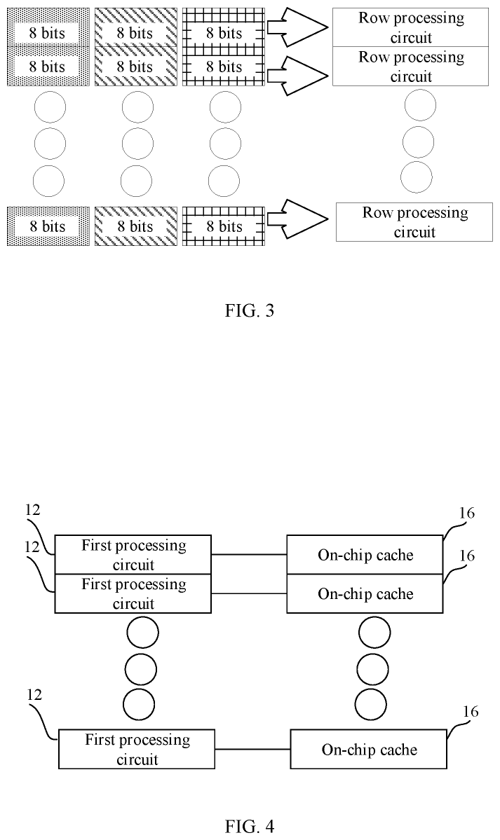

The temporary pooling result computed and obtained by the first processing circuit 12 may be saved in an on-chip cache or in an external storage device via the system bus, which is not limited by embodiments of the present disclosure. In connection with FIG. 4, a possible storage manner for the temporary pooling result is described.

As shown in FIG. 4, the pooling device 10 further includes a plurality of on-chip caches 16. The plurality of on-chip caches 16 correspond to the plurality of first processing circuits 12. Each of the on-chip caches 16 may be configured to store the temporary pooling result computed and obtained by the corresponding first processing circuit 12.

In embodiments of the present disclosure, the dedicated on-chip caches 16 may be arranged for the first processing circuits 12, which may cause the computation process of each temporary pooling result of each first processing circuit 12 to be completed on the chip as much as possible and reduce data exchange between the pooling device and the external storage device during the pooling process. As such, the computation efficiency of the pooling device may be improved.

In some embodiments, the capacity of the on-chip cache 16 may be configured to cause the capacity of the on-chip cache 16 to be sufficient to store the temporary pooling results corresponding to the pixels of one row or one column of the input image.

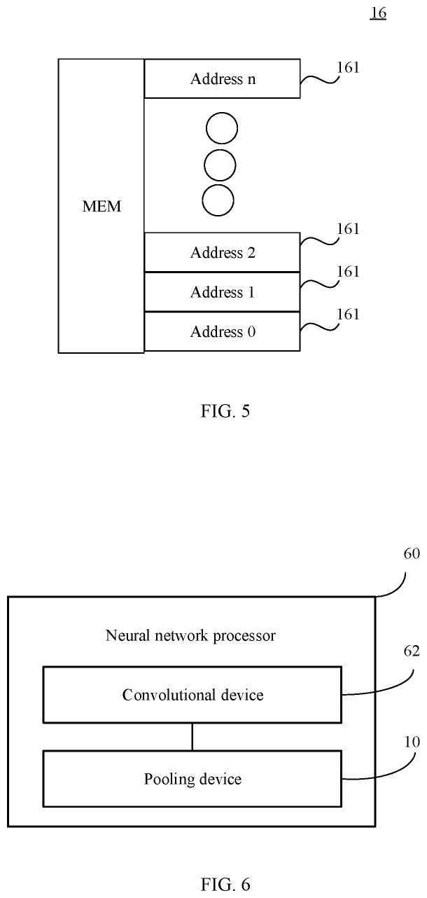

In some embodiments, as shown in FIG. 5, a storage address 161 of the on-chip cache 16 may be used to store a temporary pooling result of the temporary pooling results corresponding to the pixels of one row or one column of the input image. The temporary pooling results stored at a same storage address of the plurality of on-chip caches 16 may correspond to a same column direction or a same row direction of the input image. In some embodiments, when the first processing circuits 12 computes the temporary pooling results of the input image along the row direction, the temporary pooling results stored at the same storage address of the plurality of on-chip caches 16 may correspond to the same column direction of the input image. When the first processing circuit 12 computes the temporary pooling results of the input image along the column direction, the temporary pooling results stored at the same storage address of the plurality of on-chip caches 16 may correspond to the same row direction of the input image. In some embodiments, input data of the second processing circuits 16 may be generated by combining the temporary pooling results stored at the same storage address of the plurality of on-chip caches 16.

The above configuration manner of the storage address of the on-chip cache 16 may allow the second processing circuit 14 to obtain the input data through a simple data combination operation. A complicated address search operation may not be needed, thus, the implementation of the pooling device may be simplified.

Assume that a depth of the on-chip cache 16 is 64, if the number of the temporary pooling results corresponding to the pixels of one row or one column of the input image is greater than 64, one processing manner may include enlarging the depth of the on-chip cache 16 to cause the on-chip cache 16 to be able to store the temporary pooling results (e.g., enlarging the depth of the on-chip cache to 512) corresponding to the pixels of the one row or the one column to satisfy most of the applications. Another processing manner may include dividing the input image to obtain a plurality of input images with smaller dimensions. Then, the pooling device may be used to perform the pooling computation on the plurality of input images individually.

The second processing circuits 14 may generate the output image based on the temporary pooling results output by the first processing circuits 12. As a possible implementation manner, the second processing circuits 14 may generate the output image based on the temporary pooling results output by the first processing circuits 12 after the first processing circuit 12 processes all rows or columns of the input image. As another possible implementation manner, every time after the first processing circuits 12 processes the pixels of a portion of rows or columns of the input image, the second processing circuits 14 may be controlled to start processing. That is, the processing processes of the first processing circuits 12 and the second processing circuits 14 may be performed alternatively. An advantage of such a processing manner is that all the temporary pooling results of the input image may not need to be stored simultaneously, thus, the requirement for the capacity of the cache may be lower.

In some embodiments, the pooling device 10 may include N first processing circuits 12 (e.g., N may be a positive integer greater than one). The pooling device 10 may further include a control circuit. The control circuit may be configured to perform the following operations. If the height or width of the pooling window is less than or equal to N, every time after the N first processing circuits 12 store the temporary pooling results corresponding to the pixels of N rows or N columns on N on-chip caches, the second processing circuits 14 may be controlled to generate a portion of pixels of the output image according to the temporary pooling results stored on the N caches.

In some embodiments, the control circuit may be further configured to, if the height or width of the pooling window is greater than N, store at least part of temporary pooling results stored on the N on-chip caches 16 on other on-chip caches or an external storage device other than the plurality of on-chip caches. The control circuit may be further configured to control the second processing circuits 14 to generate a portion of or all the pixels of the output image according to the temporary pooling results corresponding to the pixels of M rows or M columns. M may be a positive integer greater than or equal to the height or width of the pooling window. The temporary pooling results corresponding to the pixels of the M rows or the M columns may include temporary pooling results stored on the other on-chip caches or the external storage device.

For example, the first processing circuit may be the row-processing circuit, and the pooling device 10 may include 16 row-processing circuits. The pooling device 10 may control the computation manner of the row-processing circuits according to the dimension of the pooling window and the storage manner of the temporary pooling results output by the row-processing circuits.

For example, pooling≤16 (pooling≤16 represents that the width and height of the pooling window are less than or equal to 16, for example, pooling=2 or pooling=16), every time after the 16 row-processing circuits processes the pixels of the 16 rows of the input image, the column processing circuits (e.g., corresponding to the above second processing circuits, the column processing circuits may reuse the row-processing circuits, that is, share the same circuits with the row-processing circuits) may be controlled to perform serial processing on the temporary pooling results corresponding to the pixels of the 16 rows to obtain the final pooling results corresponding to the pixels of the 16 rows.

For example, pooling>16 (e.g., pooling=32), since the complete pooling operation cannot be performed using the temporary pooling results corresponding to the pixels of the 16 rows, the data stored on the on-chip caches may be combined first, and the combined input may be stored on other on-chip caches (e.g., greater temporary on-chip caches) or an external storage device (e.g., off-chip double data rate (DDR) memory). After the temporary pooling results output by the row-processing circuits may finish the complete pooling operation, the data may be read from the other on-chip caches or the external storage device, and the column processing circuits may process the data.

In some embodiments, when pooling≤16, a processing manner similar to the processing manner of pooling>16 may be used for processing. An advantage of the processing manner is that no matter what the dimension of the pooling window is, the pooling device 10 may maintain the same processing manner, thus, only one universal circuit may need to be designed.

According to the above description, the input image may include the image of the ROI. The pooling device 10 may be configured to perform the ROI pooling. The analysis of the ROI may be performed by software, which is configured for the pooling device 10 or performed by the pooling device 10 itself.

For example, the pooling device 10 may further include an analysis circuit 19. The analysis circuit 19 may be configured to receive the feature image output by the convolutional layer and ROI parameters, determine the position of the ROI in the feature image according to the ROI parameters, and use the image of the ROI as the input image to be transmitted to the one or more first processing circuits 16. The analysis manner of the position of the ROI in the feature image is not described in detail here.

Embodiments of the present disclosure further provide a neural network processor. As shown in FIG. 6, the neural network processor 60 includes a convolutional device 62 and a pooling device 10. The pooling device 10 may be configured to perform the pooling operation on the feature image output by the convolutional device 62.

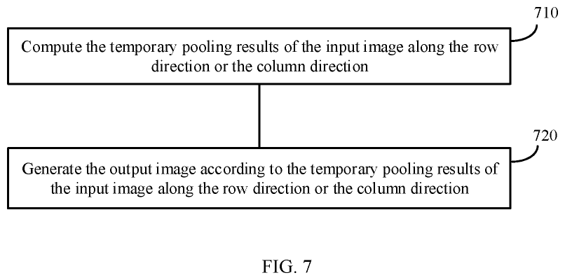

In connection with FIG. 1 to FIG. 6, device embodiments of the present disclosure are described in detail. In connection with FIG. 7, method embodiments of the present disclosure are described in detail. The description of the method embodiments may correspond to the description of the device embodiments, thus, for the part of the method embodiments not described in detail, reference can be made to the corresponding part of the device embodiments.

FIG. 7 is a schematic flowchart of a pooling method according to some embodiments of the present disclosure. The pooling method shown in FIG. 7 may be used to perform the pooling operation on the input image to generate the pooled output image. The method shown in FIG. 7 includes process 710 and process 720.

At 710, the temporary pooling results of the input image along the row direction or the column direction are computed.

At 720, the output image is generated according to the temporary pooling results of the input image along the row direction or the column direction.

In some embodiments, process 710 may include using the plurality of first processing circuits to compute in parallel the temporary pooling results of the pixels of the plurality of rows or the plurality of columns of the input image.

In some embodiments, the number of the first processing circuits may be matched with the number of the clock cycles needed for the one first processing circuit to process the target pixels. The target pixels may be the to-be-processed pixels received by the one first processing circuit in a clock cycle.

In some embodiments, the method shown in FIG. 7 may further include storing the temporary pooling results computed and obtained by the plurality of first processing circuits on the plurality of on-chip caches corresponding to the plurality of first processing circuits.

In some embodiments, the capacity of the on-chip cache may store the temporary pooling results corresponding to the pixels of one row or one column of the input image.

In some embodiments, a storage address of the on-chip cache may be used to store a temporary pooling result of the temporary pooling results corresponding to the pixels of one row or one column of the input image. The temporary pooling results stored at the same storage address of the plurality of on-chip caches may correspond to the same column direction or the same row direction of the input image. Before process 720, the method shown in FIG. 7 may further include combining the temporary pooling results stored at the same storage address of the plurality of on-chip caches.

In some embodiments, process 720 may include, if the height or width of the pooling window is less than or equal to N, every time after the N first processing circuits store the temporary pooling results corresponding to the pixels of N rows or N columns on the N on-chip caches, generating a portion of the pixels of the output image according to the temporary pooling results stored on the N on-chip caches. N denotes the number of the first processing circuits. N may be a positive integer greater than one.

In some embodiments, before process 720, the method shown in FIG. 7 may further include, if the height or width of the pooling window is greater than N, storing at least a portion of the temporary pooling results stored on the N on-chip caches on the other on-chip caches or the external storage device other than the on-chip caches. Process 720 may include generating the portion of or all the pixels of the output image according to the temporary pooling results corresponding to the pixels of M rows or M columns. M may be a positive integer greater than or equal to the height or width of the pooling window. The temporary pooling results corresponding to the pixels of the M rows or the M columns may include the temporary pooling results stored on the other on-chip caches or the external storage device.

In some embodiments, the output image may be computed and obtained based on the one or more second processing circuits. At least one of the first processing circuits and at least one of the second processing circuits may share the same circuit.

In some embodiments, the first processing circuit may process the computation corresponding to a pixel every clock cycle.

In some embodiments, the pooling device may be the field-programmable gate array (FPGA) or the application-specific integrated circuits (ASIC).

In some embodiments, the input image may be the image of ROI.

In some embodiments, the method shown in FIG. 7 may further include receiving the feature image output by the convolutional layer and the ROI parameters, determining the position of the ROI in the feature image according to the ROI parameters, and using the image of the ROI as the input image.

Above embodiments may be implemented in whole or in part by software, hardware, firmware, or any other combination thereof. When implemented by software, embodiments may be implemented in the form of a computer program product in whole or in part. The computer program product includes one or more computer instructions. When the computer program instructions are loaded and executed on the computer, the processes or functions described consistent with embodiments of the present application are generated in whole or in part. The computer may include a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be transmitted from a website, computer, server, or data center to another website, computer, server or data center through a wired manner (such as coaxial cable, optical fiber, digital subscriber line (DSL)) or a wireless manner (such as infrared, wireless, microwave, etc.). The computer-readable storage medium may include any available medium that can be accessed by a computer or a data storage device such as a server or a data center integrated with one or more available media. The available medium may be a magnetic medium (e.g., a floppy disk, a hard disk, a magnetic tape), an optical medium (e.g., a digital video disc (DVD)), or a semiconductor medium (e.g., a solid-state disk (SSD)), etc.

Without conflict, various embodiments and/or the various technical features of embodiments described in the present disclosure may be combined with each other arbitrarily. The technical solutions obtained after the combination should be within the scope of the present disclosure.

Those of ordinary skill in the art may be aware that the units and algorithm steps of the examples described in embodiments disclosed in the present disclosure may be implemented by electronic hardware or a combination of computer software and electronic hardware. Whether these functions are executed by hardware or software depends on the specific application and design constraint conditions of the technical solution. Those skilled in the art may use different methods to implement the described functions for each specific application, but such implementation should not be considered beyond the scope of the present disclosure.

In some embodiments of the present disclosure, the disclosed system, device, and method may be implemented in other manners. For example, device embodiments described above are merely illustrative. For example, the division of the units is only a logical function division, and other divisions may exist in actual implementation. For example, multiple units or components may be combined or integrated into another system, or some features may be ignored or not implemented. In addition, the displayed or discussed mutual coupling or direct coupling or the communication connection may be the indirect coupling or the communication connection through some interfaces, devices, or units, and may be in electrical, mechanical, or other forms.

The units described as separate components may or may not be physically separated, and the components displayed as units may or may not be physical units. That is, they may be located in one place, or they may be distributed on multiple network units. Some or all of the units may be selected according to actual needs to achieve the objectives of the solutions of embodiments.

In addition, the functional units of embodiments of the present disclosure may be integrated into one processing unit, or each unit may exist alone physically, or two or more units may be integrated into one unit.

The above are only specific embodiments of the present disclosure, but the scope of the present disclosure is not limited to this. Those skilled in the art may easily think of changes or substitutions within the technical scope disclosed in the present disclosure. Those changes or substitutions should be within the scope of the present disclosure. Therefore, the scope of the invention should be subject to the scope of the claims.

What is claimed is:

1. A pooling device comprising:
one or more first processing circuits configured to compute temporary pooling results of an input image along a row direction or a column direction; and
one or more second processing circuits configured to generate an output image according to the temporary pooling results of the input image along the row direction or the column direction.

2. The pooling device of claim 1, wherein the one or more first processing circuits include a plurality of first processing circuits configured to compute temporary pooling results of a plurality of rows or a plurality of columns of the input image in parallel.

3. The pooling device of claim 1, wherein a number of the one or more first processing circuits equals a number of one or more clock cycles needed for one of the one or more first processing circuits to process target pixels, the target pixels being to-be-processed pixels received by the one of the one or more first processing circuits in a clock cycle.

4. The pooling device of claim 1, further comprising:
one or more on-chip caches corresponding to the one or more first processing circuits, each of the one or more on-chip caches being configured to store temporary pooling results computed and obtained by a corresponding one of the one or more first processing circuits.

5. The pooling device of claim 4, wherein a capacity of one of the one or more on-chip caches is enough to store temporary pooling results corresponding to pixels of a row or a column of the input image.

6. The pooling device of claim 4, wherein:
a storage address of one of the one or more on-chip caches is used to store one of temporary pooling results corresponding to pixels of a row or a column of the input image;
temporary pooling results stored at a same storage address of the one or more on-chip caches correspond to a same column direction or a same row direction of the input image; and
input data of the one or more second processing circuits is obtained by combining the temporary pooling results stored at the same storage address of the one or more on-chip caches.

7. The pooling device of claim 4,
wherein the one or more first processing circuits include N first processing circuits, N being a positive integer greater than one;
the pooling device further comprising:
a control circuit configured to, in response to a height or a width of a pooling window being less than or equal to N, every time after the N first processing circuits store temporary pooling results corresponding to pixels of N rows or N columns into N on-chip caches, control the one or more second processing circuits to generate a portion of pixels of the output image according to the temporary pooling results stored in the N on-chip caches.

8. The pooling device of claim 7, wherein the control circuit is further configured to, in response to the height or the width of the pooling window being greater than N:
store at least a portion of the temporary pooling results stored on the N on-chip caches into other on-chip caches other than the one or more on-chip caches or an external storage device; and
control the one or more second processing circuits to generate a portion of or all of pixels of the output image according to temporary pooling results corresponding to pixels of M rows or M columns, M being a positive integer greater than or equal to the height or the width of the pooling window, and the temporary pooling results corresponding to the pixels of the M rows or the M columns including the temporary pooling results stored on the other on-chip caches or the external storage device.

9. The pooling device of claim 1, wherein at least one of the one or more first processing circuits and at least one of the one or more second processing circuits share a same circuit.

10. The pooling device of claim 1, wherein the input image is an image of a region of interest (ROI).

11. The pooling device of claim 10, further comprising:
an analysis circuit configured to:
receive a feature image and ROI parameters output by a convolutional layer;
determine a position of the ROI in the feature image according to the ROI parameters; and
transmit the image of the ROI as the input image to the one or more first processing circuits.

12. The pooling device of claim 1, wherein one of the one or more first processing circuits processes computation corresponding to one pixel every clock cycle.

13. The pooling device of claim 1, further comprising:
a field-programmable gate array (FPGA) or an application-specific integrated circuit (ASIC).

14. A neural network processor comprising:
a convolutional device; and
a pooling device including:
one or more first processing circuits configured to compute a temporary pooling result of an input image from the convolutional device along a row direction or a column direction; and
one or more second processing circuits configured to generate an output image according to the temporary pooling result of the input image along the row direction or the column direction.

15. A pooling method comprising:
computing, using one or more first processing circuits, temporary pooling results of an input image along a row direction or a column direction; and
generating, using one or more second processing circuits, an output image according to the temporary pooling results of the input image along the row direction or the column direction.

16. The method of claim 15, wherein the one or more first processing circuits include a plurality of first processing circuits, and computing the temporary pooling results of the input image along the row direction or the column direction includes:
using the plurality of first processing circuits to compute temporary pooling results of pixels of a plurality of rows or a plurality of columns of the input image in parallel.

17. The method of claim 15, wherein a number of the one or more first processing circuits equals a number of one or more clock cycles needed for one of the one or more first processing circuits to process target pixels, the target pixels being to-be-processed pixels received by the one of the one or more first processing circuits in a clock cycle.

18. The method of claim 15, further comprising:
storing the temporary pooling results computed and obtained by the one or more first processing circuits on one or more on-chip caches corresponding to the one or more first processing circuits.

19. The method of claim 18, wherein a capacity of one of the one or more on-chip caches is enough to store the temporary pooling results corresponding to pixels of a row or a column of the input image.

20. The method of claim 18,
wherein:
a storage address of one of the one or more on-chip caches is used to store one of the temporary pooling results corresponding to pixels of a row or a column of the input image; and
temporary pooling results stored at a same storage address of the one or more on-chip caches correspond to a same column direction or a same row direction of the input image;
the method further comprising, before generating the output image according to the temporary pooling results of the input image along the row direction or the column direction:
combining the temporary pooling results stored at the same storage address of the one or more on-chip caches.
